(19) United States
(12) Patent Application Publication
(10) Pub. No.: US 2026/0008513 A1
(43) Pub. Date: Jan. 8, 2026

(54) BICYCLE ACTUATING DEVICE AND BICYCLE ACTUATING SYSTEM

(71) Applicant: SRAM DEUTSCHLAND GmbH, SCHWEINFURT (DE)

(72) Inventors: Jochen Bierwerth, Arnstein (DE); Lea Huempfer, Bergrheinfeld (DE)

(73) Assignee: SRAM DEUTSCHLAND GmbH, SCHWEINFURT (DE)

(21) Appl. No.: 19/247,070

(22) Filed: Jun. 24, 2025

(30) Foreign Application Priority Data
Jul. 3, 2024 (DE) 102024118906.1

(51) Int. Cl. B62K 23/06; B62J 1/08; B62M 6/45; B62M 25/04

(52) U.S. Cl. CPC B62K 23/06; B62J 1/08; B62M 6/45; B62M 25/04; B62J 2001/085

(57) ABSTRACT

A bicycle actuating device includes a main body, in the form of a housing, an actuating element, mounted so as to be able to move on the main body, a fastening portion having at least one fastening opening for fastening the bicycle actuating device to a handlebar clamp of a bicycle, wherein the fastening portion protrudes from the main body and the fastening opening is formed as a through-opening that connects two fastening faces on opposite sides of the fastening portion to one another. A bicycle actuating system includes, in addition to such a bicycle actuating device, a handlebar clamp or/and a spacer or/and a further bicycle actuating device, wherein the bicycle actuating device and the spacer or/and the further bicycle actuating device can be mounted so as to be stacked on top of one another at the same circumferential position of the handlebar clamp using a single fastening element.

This application claims the benefit of DE Application No. 102024118906.1, filed Jul. 3, 2024, the contents of which is hereby incorporated by reference in its entirety.

### BACKGROUND

The present application relates to a bicycle actuating device, also referred to here as actuating device for short.

A conventional bicycle actuating device, as is known, for example, from documents U.S. Pat. No. 8,061,667 B2 and U.S. Pat. No. 8,061,667 B2, comprises a main body, in particular in the form of a housing, an actuating element, which is preferably mounted so as to be able to move on the main body, and a fastening portion having at least one fastening opening for fastening the bicycle actuating device to a handlebar clamp of a bicycle.

Current bicycles have a variety of controllable components, such as derailleurs, a seat post, dampers or a suspension fork, brakes, e-bike motors, etc. For easy accessibility and safe operation even while riding, the actuating devices for all of these components are usually mounted on the handlebar of the bicycle, and therefore it is of great interest to position the various actuating devices in a manner that is space-saving, ergonomic and can be adapted to the different requirements of various riders.

Mounting each individual actuating device using a separate handlebar clamp would result in space and accessibility problems. Solutions are therefore known from the abovementioned prior art in which various actuating devices can be fastened at different circumferential positions on a single handlebar clamp by corresponding clamp adapters, which can, however, adversely affect the accessibility of the individual actuating devices.

### SUMMARY

According to one aspect, a bicycle actuating device, includes a main body in the form of a housing, an actuating element, which is mounted so as to be able to move on the main body, a fastening portion having at least one fastening opening for fastening the bicycle actuating device to a handlebar clamp of a bicycle. Where the fastening portion protrudes from the main body and the at least one fastening opening is formed as a through-opening that connects two fastening faces on opposite sides of the fastening portion to one another.

According to a second aspect, a bicycle actuating system includes a bicycle actuating device having a main body in the form of a housing, an actuating element, which is mounted so as to be able to move on the main body, a fastening portion having at least one fastening opening for fastening the bicycle actuating device to a handlebar clamp of a bicycle. Where the fastening portion protrudes from the main body and the at least one fastening opening of the fastening portion is formed as a through-opening that connects two fastening faces on opposite sides of the fastening portion to one another. The bicycle actuating system includes at least one spacer formed separately from the bicycle actuating device and having at least one fastening opening formed as a through-opening, having a plurality of such fastening openings arranged along a line. Where the spacer is configured to be selectively mounted on either one of the two fastening faces of the fastening portion, so that the at least one fastening opening of the bicycle actuating device and the at least one fastening opening of the spacer are arranged coaxially with one another.

### BRIEF DESCRIPTION OF DRAWINGS

FIG. 1 shows a bicycle actuating device in the form of an e-bike controller according to a first exemplary embodiment in a first perspective view;

FIG. 2 shows the subject matter in a second perspective view;

FIG. 3 shows an enlargement of a section of a cross-sectional view of the subject matter of FIG. 1 in a sectional plane indicated in FIG. 1 and indicated by III-III therein;

FIG. 4 shows a bicycle actuating system according to a first exemplary embodiment having the e-bike controller according to the preceding figures and a spacer in a first perspective view;

FIG. 5 shows the subject matter of FIG. 4 in a second perspective view;

FIG. 6 shows the subject matter of FIG. 4 in a side view;

FIG. 7 shows the subject matter of FIG. 4 in an exploded illustration;

FIG. 8 shows a bicycle actuating system according to a second exemplary embodiment having the e-bike controller according to FIG. 1, a dropper remote as a further actuating device, a brake actuating device and a handlebar clamp having a clamp adapter in a first perspective view;

FIG. 9 shows an exploded illustration of the subject matter of FIG. 8;

FIG. 10 shows an exploded illustration of the subject matter of FIG. 8;

FIG. 11 shows the bicycle actuating system from FIG. 8 when mounted on the handlebar in a first perspective illustration; and

FIG. 12 shows a bicycle having the bicycle actuating system according to FIG. 8.

Features of various exemplary embodiments that are the same or correspond to one another are each denoted by the same reference sign, wherein, for the sake of clarity, not all of the features are provided with reference signs, but rather primarily those that are used to explain the respective exemplary embodiment. If there are several identifiably identical features, a reference sign is not always provided for each feature.

### DETAILED DESCRIPTION

Against this background, the object of the present invention is to improve the known bicycle actuating device with regard to the flexible and space-saving arrangement of a plurality of devices on a single handlebar clamp.

In order to achieve this object, it is proposed that the fastening portion protrudes away from the main body and the fastening opening is formed as a through-opening that connects two fastening faces on opposite sides of the fastening portion to one another.

In contrast to the prior art, in which the fastening openings of the bicycle actuating devices are formed as blind holes, the solution according to the invention enables a plurality of components to be fixed to one another and also to a handlebar clamp at the same circumferential position using a single fastening element guided through the fastening opening, wherein the fastening face of the fastening portion that faces away from the handlebar clamp serves as the fastening face for a further component.

In order to be able to vary the position of the bicycle actuating device depending on the user's preference, the fastening portion can be formed as an elongate web and have a plurality of fastening openings that are arranged along a first predetermined direction and formed as through-openings, wherein the fastening portion preferably protrudes from the main body in this first direction as well.

The positioning can be facilitated by virtue of at least certain portions of the fastening portion having a constant cross-sectional contour in the cross section perpendicular to the first predetermined direction and thus enabling, prior to fixing using the fastening element, a relative movement between the bicycle actuating device and the further component to be fastened thereto or the handlebar clamp along the first direction. In particular, the fastening portion can act as a rail for guiding the bicycle actuating device relative to the handlebar clamp or for guiding a further component relative to the bicycle actuating device along the first predetermined direction.

According to a preferred exemplary embodiment, provision is also made for the two fastening faces on opposite sides of the fastening portion to be formed in such a manner that the fastening portion and a further, separate component part, at least certain portions of which have substantially the same shape as the fastening portion, can be stacked on top of one another in any order along a second predetermined direction, wherein the second predetermined direction runs parallel to an axial direction of the at least one fastening opening of the fastening portion and preferably also perpendicular to the first predetermined direction.

As will be explained in more detail below, this further component part can be, for example, a spacer or a further bicycle actuating device.

For the desired stacking capability, provision can in particular be made for at least certain portions of the two fastening faces on opposite sides of the fastening portion to be formed in a complementary manner to one another so that, for each recess on one fastening face in the respective portion, a corresponding projection, which fits into or would fit into the recess, is provided in the other fastening face, and vice versa.

As a positioning aid, the fastening portion can also be formed such that the fastening portion and the further component part, when stacked on top of one another, are in engagement (form-fitting engagement) such that a mutual relative movement in and counter to a third predetermined direction, which runs perpendicular to the second predetermined direction and preferably also perpendicular to the first predetermined direction, is prevented.

It should also not be ruled out that the fastening portion has structures such that the fastening portion and the further component part, when stacked on top of one another, adhere to one another at least temporarily in the manner of clamping building blocks, with the result that, during the final fixing using a fastening element, the user does not have to secure the pre-positioned components that are stacked on top of one another.

In addition, protection is also claimed for a bicycle actuating system (actuating system for short) having at least one bicycle actuating device, as described in the introduction, and at least one spacer formed separately from the bicycle actuating device.

The spacer has at least one fastening opening formed as a through-opening, preferably a plurality of fastening openings formed as through-openings arranged in a line, and is configured to be selectively mounted on either one of the two fastening faces of the fastening portion of the bicycle actuating device, so that the at least one fastening opening of the bicycle actuating device and the at least one fastening opening of the spacer are arranged coaxially with one another, so that the spacer and actuating device can be fastened to one another and preferably also to the handlebar clamp using a single fastening element guided through the coaxial openings.

One or more such spacers, depending on hand size and preferences, enable the distance to the handlebar or/and the distance between different components (actuating devices) that are stacked on top of one another to be adjusted, wherein the interfaces between the components or the components and the spacers preferably engage in a form-fitting manner, in particular in the manner of clamping building blocks.

A bicycle actuating system, in particular a system having a spacer, as described above, can also comprise, in addition to the bicycle actuating device, a handlebar clamp, wherein the bicycle actuating device and the handlebar clamp are configured for mounting the bicycle actuating device on the handlebar clamp, preferably using the same fastening element with which at least one further component can be mounted on the bicycle actuating device.

Preferably, the bicycle actuating system also comprises a fastening element, for instance in the form of a screw or a screw-nut combination, with which the actuating device or the actuating devices and optionally the spacer, when stacked on top of one another, can be mounted together at a preferably selected circumferential position of the handlebar clamp.

For an actuating device having a plurality of fastening openings arranged in a line along the first predetermined direction, the first direction runs, when the actuating device is fastened to the handlebar clamp, preferably substantially parallel to an axis of the handlebar clamp, so that, when mounted, it is possible to adjust the position of the actuating device relative to the clamp in the direction of the handlebar axis.

Furthermore, provision can be made for the bicycle actuating device to further comprise a brake actuating device, which is preferably configured to be mounted between circumferential ends of the handlebar clamp. However, it is also possible for a brake actuating device to be mounted on the handlebar clamp or on a separate clamp in another suitable manner.

In principle, it should not be excluded to use special handlebar clamps that are designed to mount the bicycle actuating device directly on the clamp at a single fixed circumferential position.

Preferably, however, the bicycle actuating system comprises a clamp adapter, which is formed separately from the clamp and is configured to be selectively attached to the handlebar clamp in various circumferential positions, and which also comprises a fastening portion having at least one fastening opening, wherein the fastening portion of the bicycle actuating device is configured to be fastened directly or indirectly, for example with the interposition of a spacer, to the fastening portion of the clamp adapter, so that the fastening opening of the handlebar clamp and the at least one fastening opening of the bicycle actuating device run coaxially with one another. Corresponding handlebar clamps and clamp adapters are known, for example, from the two documents mentioned in the introduction.

In one embodiment, the bicycle actuating system can comprise yet a further bicycle actuating device, preferably also according to the invention, having a fastening portion and a fastening opening formed therein, wherein the two actuating devices can be mounted on one another to form an assembly such that their two fastening portions are stacked on top of one another, so that the at least one fastening opening of the fastening portion of one bicycle actuating device and the at least one fastening opening of the fastening portion of the other bicycle actuating device are arranged coaxially with one another.

In the case of a bicycle actuating system having two bicycle actuating devices, a handlebar clamp and at least one spacer, as described above, provision can in particular be made for the spacer and the two actuating devices that are mounted on one another or stacked on top of one another in various configurations to be able to be fastened to the handlebar clamp, in particular using a single fastening element, for instance a screw or a bolt, wherein the spacer is arranged, in one of the configurations, between the fastening portions of the two bicycle actuating devices and is arranged, in another of the configurations, between the handlebar clamp and the fastening portions, which are directly mounted on one another, of the two actuating devices.

The individual actuating devices can be, for example, a gearshift-mechanism actuating device, a seat post actuating device (dropper remote), an e-bike controller or a bicycle computer.

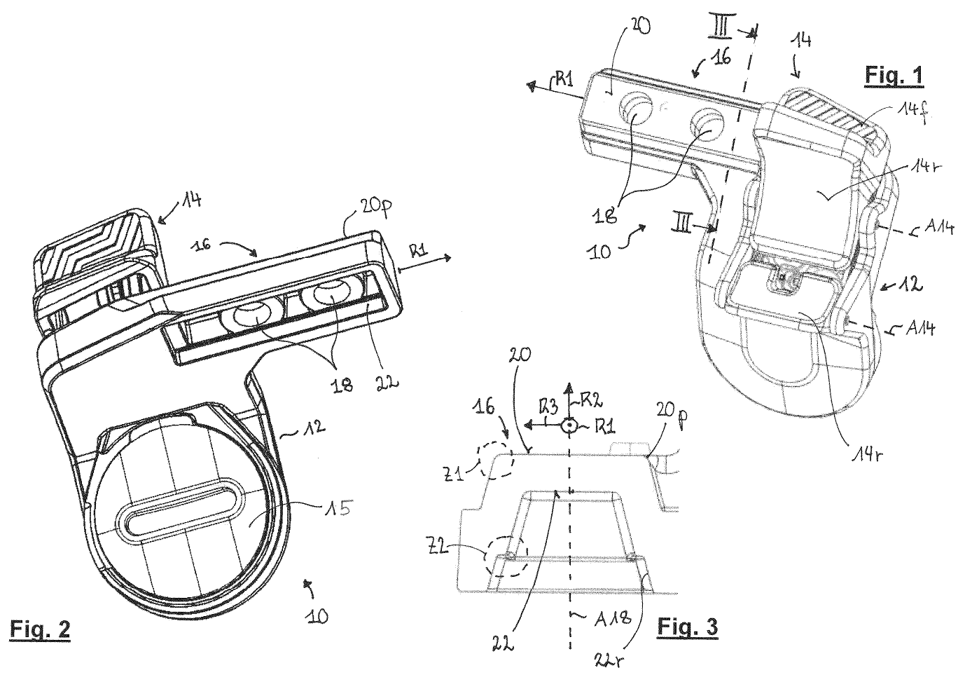

As mentioned above, FIGS. 1 and 2 illustrate a bicycle actuating device 10, in this case in the form of an e-bike controller 10A, according to a first exemplary embodiment in various views. The actuating device 10 comprises a main body 12, which is formed in this case in the form of a housing in which the battery and electronics of the controller are accommodated. A battery compartment cover 15 on the rear side of the housing enables the battery to be replaced.

As actuating elements 14, two rockers on two separate axes A14 are in this case mounted so as to be able to move on the main body 12 and are used, for example, for operating three or more electronic shifters that are not visible in this case and can also be assigned several times depending on the type or duration of the actuation.

A fastening portion 16 formed as an elongate web protrudes laterally away from the main body 12 in a first predetermined direction R1, and a plurality of fastening openings 18 arranged along a line in the first direction R1 are formed in the fastening portion 16.

The fastening openings 18 are formed as through-openings and connect two fastening faces 20, 22 on opposite sides of the fastening portion 16, one of which can be seen in the view in FIG. 1, the other in the view of FIG. 2.

Axes A18 of the fastening openings 18 extend parallel to one another in a second predetermined direction R2, which runs perpendicular to the first direction R1, and which can be seen most clearly in the cross-sectional view of FIG. 3.

The sectional plane of the view of FIG. 3 runs perpendicular to the first predetermined direction R1 and its position is indicated in FIG. 1 by a dashed line and designated III-III.

In FIG. 3, it can be seen most clearly that the fastening portion 16 is specifically formed such that the fastening portion 16 and a separate component part, at least certain portions of which have substantially the same shape as the fastening portion 16, can be stacked on top of one another in any order along the second predetermined direction R2.

In particular, at least certain portions of the two fastening surfaces 20, 22 are formed in a complementary manner to one another, for example in the regions designated Z1 and Z2 in FIG. 3, so that in two structurally identical fastening portions, for example of the actuating device and the separate component part, a trapezoidal projection 20p formed on the fastening surface 20 of one fastening portion fits into, and bears against, a corresponding trapezoidal recess 22r formed on the fastening surface 22 of the other fastening portion, and vice versa.

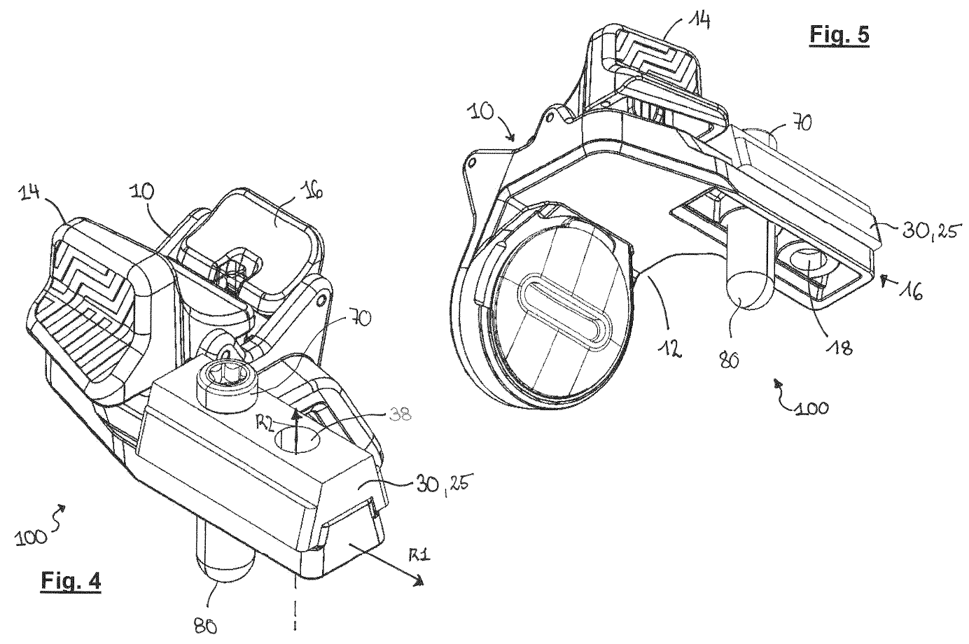

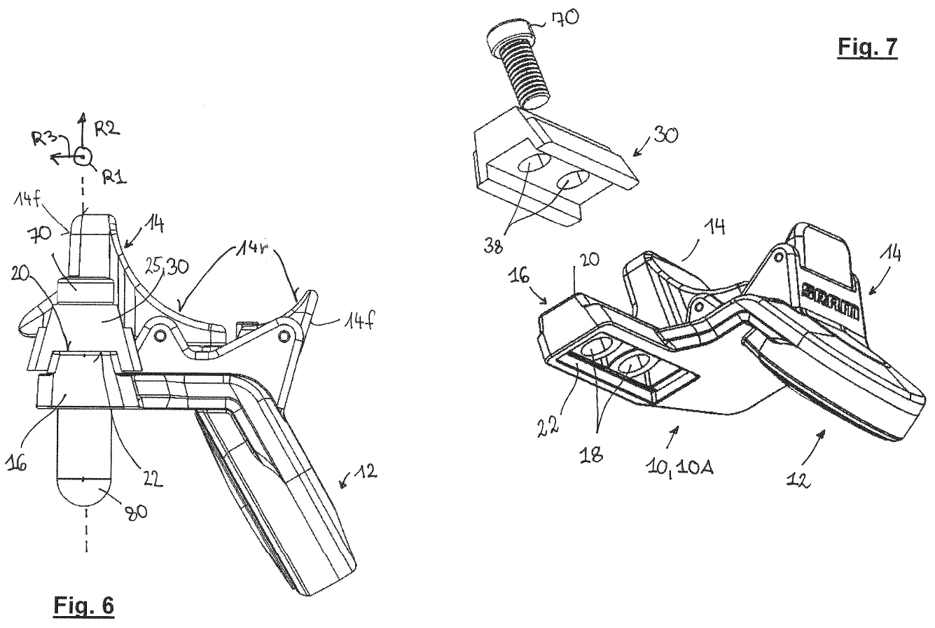

Such a further component part 25, which is designed to be able to be stacked in any order in combination with the fastening portion 16 in the direction R2, can be, for example, a spacer 30, which, together with the bicycle actuating device 10 according to FIGS. 1-3, can be part of a bicycle actuating system 100 according to one exemplary embodiment, which is shown in various views in FIGS. 4-7.

For the sake of completeness, it should be noted that the actuating device 10 of FIGS. 1-3 is designed to be fastened on the right-hand handlebar side, but the system of the following FIGS. 4-11 is designed to be fastened on the left-hand handlebar side, with the result that the components are correspondingly formed mirror-symmetrically.

For example, the spacer 30 can be used to vary the distance, preferably the radial distance, of the actuating device 10 to the handlebar or the distance between the actuating device 10 and a further component. In addition, a plurality of stackable and in particular similar spacers 30 can be present in order to vary the size of the distance.

As can be seen in particular in the exploded illustration in FIG. 7 and the side view in FIG. 6, the spacer 30 has substantially the same shape as the fastening portion 16, in particular in the cross section in a sectional plane perpendicular to the first direction R1.

The mutually matching and engaging structures of the fastening portion 16 and spacer 30 in this case act as rails for guiding a relative movement of the two components 10, 30 along the first direction R1 and for preventing a relative movement in and counter to a third direction R3, which runs perpendicular to both the first direction R1 and the second direction R2.

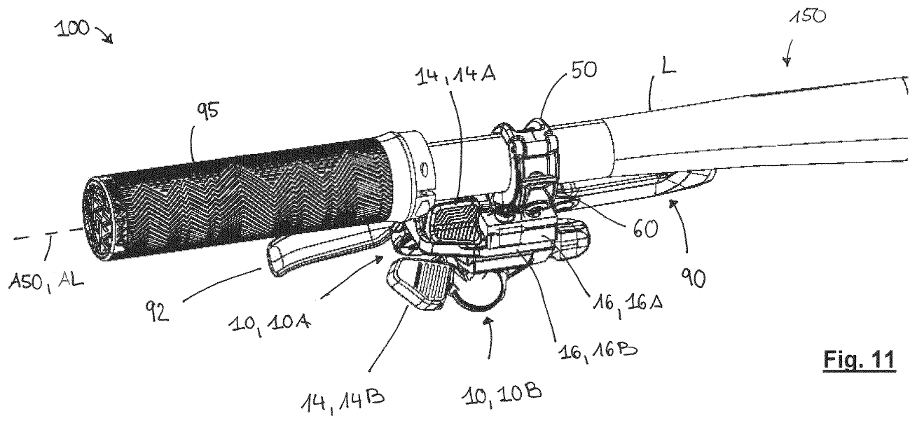

In the side view of FIG. 6 it can be clearly seen that the shape of the rear sides 14r of the actuating faces 14f of the actuating elements 14 of the bicycle actuating device 10 is adapted to the rounding of a handlebar L, so that the actuating device 10 can be positioned particularly close to the handlebar L (cf. FIG. 11).

The actuating system 100 of FIGS. 4 to 7 further comprises a screw 70 with a screw nut 80 as a fastening element for fixing the adapter 30 to or below the fastening portion 16, i.e. to either one of the two fastening faces 20, 22. The screw 70 and the associated nut 80 should in this case be understood as a single fastening element.

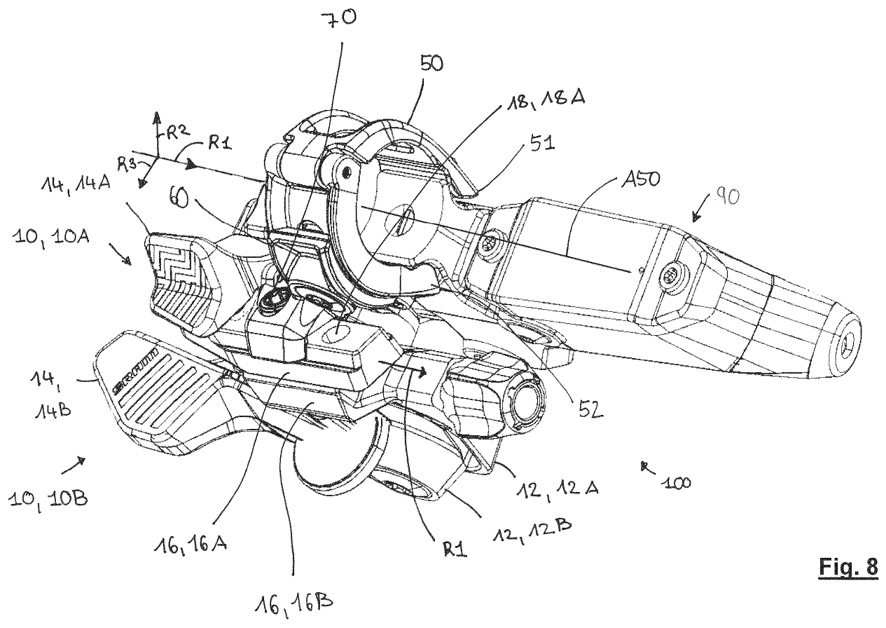

FIGS. 8-11 illustrate another exemplary embodiment of a bicycle actuating system 100.

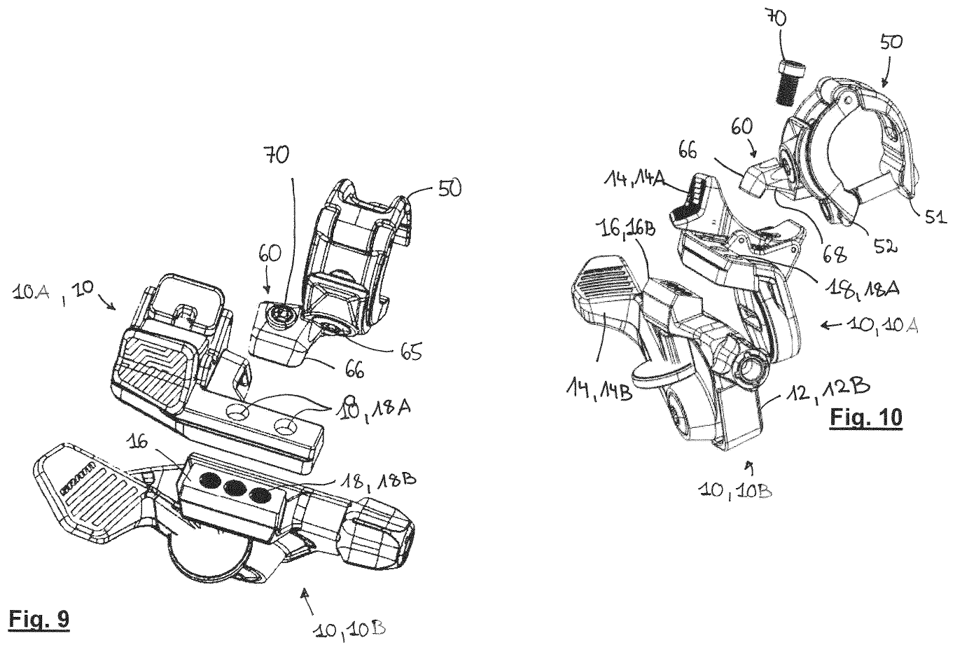

FIG. 8 shows the actuating system 100 when assembled. It comprises, in addition to the e-bike controller 10A shown in all of the previous figures as the first bicycle actuating device 10, a second bicycle actuating device 10, preferably also according to the disclosure, in this case in the form of a seat post actuating device 10B (dropper remote), and a handlebar clamp 50 with a clamp adapter 60 and a brake actuating device 90, which is not shown in FIGS. 9 and 10, however.

Moreover, if it is important to distinguish between the two bicycle actuating devices, the reference signs of the components of the e-bike controller 10A are in this case also provided with the suffix A and the reference signs of the components of the seat post actuating device 10B are also provided with the suffix B. If a distinction is not important, the suffixes can be omitted.

The brake actuating device 90 can be fixed in a known manner between the two free circumferential ends 51, 52 of the handlebar clamp 60.

In the present example, the handlebar clamp 50 and clamp adapter 60 are formed as illustrated in the exemplary embodiments of U.S. Pat. No. 8,061,667B2, the more detailed description of which can be referred to here.

The clamp adapter 60 can be positioned in various circumferential positions on the clamp 50 and fixed in the respective selected position of the handlebar clamp 50 using a screw 65 and a specially designed screw nut, which is not visible here.

Furthermore, the clamp adapter 60 has a fastening portion 66 having a fastening opening 68. The fastening portions 66, 16A of the clamp adapter 60 and bicycle actuating device 10A are formed so that, when the fastening openings 68, 18A are coaxially arranged, the actuating device 10A can be fastened directly or indirectly (e.g. with the interposition of a spacer 30) to the clamp adapter 60 using a single fastening element 70, 80.

As can be seen in FIG. 8, the first predetermined direction R1 of the first actuating device 10, when assembled, runs substantially parallel to the axis A50 of the handlebar clamp 50, so that by selecting that fastening opening 18A of the actuating device 10A that is used for fastening to the clamp 50, the axial position of the actuating elements 14A relative to the handlebar clamp 50 and thus e.g. relative to the brake lever 92 or handlebar grip 95 can be adjusted (cf. FIG. 11).

The second bicycle actuating device 10, i.e. in this case the seat post actuating device 10B (dropper remote), has a fundamentally similar construction to the first actuating device 10A, having a main body 12, a movably mounted pivot lever as an actuating element 14 and a web-like fastening portion 16 having three fastening openings 18, which are in this case arranged along a line in the first predetermined direction R1, are formed as through-openings and make it possible to vary the position of the second actuating device 10B relative to the first actuating device 10A in the first direction R1.

However, in contrast to the e-bike controller 10A, in the case of the actuating device 10B, the fastening portion 16B does not protrude from the main body 12B in the first predetermined direction R1, but instead in the third predetermined direction R3.

Since, in some cases, a certain stacking order of the various actuating devices 10 to be fastened at the same circumferential position of the handlebar clamp 50 can be predefined, for instance because the positions of the various actuating elements 14 are specifically adapted to this order with regard to easy accessibility, the fastening openings 18 of that actuating device 10 (in this case 10B) that is to be fastened radially furthest from the handlebar clamp 50, unlike in the figures, do not necessarily have to be formed as through-openings. Correspondingly, the fastening portion of this actuating device does not necessarily have to protrude from its main body either.

If an internal thread is provided in the fastening openings of the actuating devices that are to be positioned furthest from the clamp, a separate screw nut can optionally be omitted.

All of the actuating devices 10A, 10B of the bicycle actuating system 100 can be attached at a single circumferential position of the handlebar clamp 50 using a single fastening element 70.

FIG. 11 shows the bicycle actuating system 100 of FIGS. 8-10 when mounted on a handlebar L of a bicycle 150. It can be seen that, on account of the stacked arrangement at the same circumferential position of the handlebar clamp 50, the actuating elements 14 of the various actuating devices 10A, 10B are easily accessible even without regripping.

As already mentioned, the shape and position of the actuating elements 14A of the e-bike controller 10A in the illustrated exemplary embodiment are adapted so as to be able to be positioned particularly close to the handlebar L.

If this results in space problems, for example because the clamp 50 is intended to be positioned axially closer to the handlebar grip 95 than is shown in FIG. 11, a spacer 30, which is not illustrated here, as illustrated, for example, in FIG. 7, can be installed between the fastening portion 66 of the handlebar clamp 50 or of the clamp adapter 60 and the fastening portion 16A of the e-bike controller 10A.

Alternatively or additionally, such a spacer 30 can also be mounted between the fastening portions 16A, 16B of the e-bike controller 10A and seat post actuating device 10B in order to increase the distance between the two actuating devices 10A, 10B.

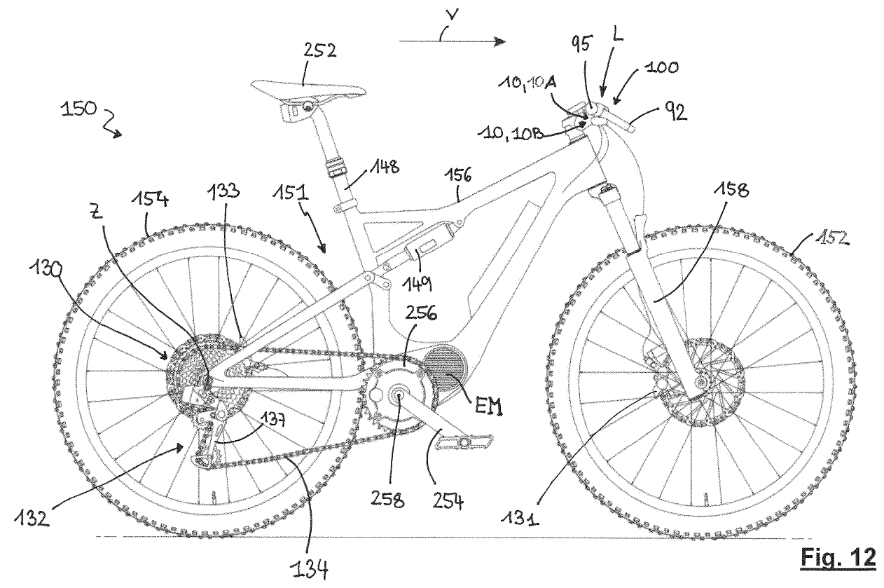

FIG. 12 shows a bicycle 150 in the form of a mountain bike having an electric auxiliary motor EM and a bicycle actuating system 100 according to one exemplary embodiment.

This bicycle 150 has, in a manner known per se, a front wheel 152, a rear wheel 154 and a frame 156. The front wheel 152 is rotatably mounted at bottom ends of a front-wheel suspension fork 158, which is rotatably held on the frame 156 at its upper end and carries a handlebar L for steering the bicycle 150. The rear wheel 154 is mounted so as to be able to rotate about a wheel axis Z on a suspended rear swingarm 151, the suspension of which can be adjusted by way of a damper unit 149. A front disc brake 131 and a rear disc brake 133 are provided for braking.

Terms such as “front”, “rear”, “top” and “bottom” refer, unless specified otherwise, to a bicycle 150 in the usual operating position with forward direction V, as indicated in FIG. 12.

The frame 156 also carries a seat 252 on an electronically adjustable seat post 148 and a crank assembly with pedal cranks 254 and a front chain ring 256 fastened thereto.

The crank assembly is mounted on the frame 156 so as to be able to rotate about a bottom bracket axle 258. A rear pinion assembly 130 (pinion cassette), which carries a plurality of pinions of different diameters, i.e. having different numbers of teeth, is mounted on the rear wheel 154 so as to be concentric to the wheel axis Z, while the front chain ring 256 can be designed as a single wheel.

In order to set the shift stages of the rear pinion assembly 130, use is made of a rear derailleur system having a rear gearshift mechanism 132, which is likewise fastened to a rear end of the frame 156. A chain 134 runs around the pinion assembly 130 and the front chain ring 256 and passes through the gearshift mechanism 132 in order to transmit driving force from the pedal cranks 254 and the front chain ring 256 to the pinion assembly 130 and thus to the rear wheel 154. The gearshift mechanism 132 is used to adjust the chain 134 in an axial direction with respect to the axis of rotation Z of the rear wheel 154, in order to align the chain 134 selectively with one of the pinions of the pinion assembly 130 and accordingly to guide it onto the selected pinion. The gearshift mechanism 132 can in particular have a derailleur 137 that can be adjusted by way of an electric motor, i.e. can be controlled electronically.

The bicycle actuating device 100 in FIG. 12 comprises an actuating unit 10 in the form of an e-bike controller 10A for controlling various functions and settings of the electric auxiliary motor EM. In this case, control commands can be transmitted wirelessly by a radio connection between a radio transmitter, which is preferably integrated in the bicycle actuating device 10A, and a radio receiver, which is integrated in or on the auxiliary motor EM.

Furthermore, the bicycle actuating device 100 in FIG. 12 also comprises an actuating unit 10 or 10B for adjusting the seat post 148. The actuating devices 10A, 10B are illustrated merely schematically in FIG. 12, but can, for example, be designed as illustrated in FIG. 11.

The type of bicycle actuating devices 10 illustrated in the figures is selected only by way of example, and the device can relate to actuating devices for any bicycle components that are, for example, mechanically or/and electronically or/and hydraulically controllable, such as, for example, the rear gearshift mechanism 132 or the damper unit 149 for the rear swingarm 151 or a damper unit for the front fork 158.

In this case, the control can be wired or wireless, and combinations are also possible. In the example shown, the controller is controlled, for example, electronically wirelessly, this being assigned to the actuating device 10A, and the seat post 148 is controlled mechanically, this being assigned to the actuating device 10B.

In many cases, the actuating elements are formed as shifters, levers, push buttons or rotary knobs and are thus movably mounted on the main body of the respective actuating device. However, this may not necessarily be applicable if, for instance, a touchscreen is provided as an actuating element. Thus, an actuating device according to the disclosure can also be used, for example, to operate a bicycle computer arranged in the center of the handlebars.

Overall, the present disclosure proposes a bicycle actuating system that enables a plurality of actuating devices stacked on top of one another to be fastened in a flexible and space-saving manner at the same circumferential position of a handlebar clamp using a single fastening element.

In particular, the fastening portions or interfaces of the various components can in this case be matched to one another such that it is possible to vary the number and order of the components stacked on top of one another.

The bicycle actuating device according to the disclosure, with its fastening portion protruding from the main body and the through-opening that is formed therein as a fastening opening and connects fastening faces on opposite sides, is specifically designed for use in such a system.

What is claimed is:

1. A bicycle actuating device, comprising:
a main body in the form of a housing,
an actuating element, which is mounted so as to be able to move on the main body,
a fastening portion having at least one fastening opening for fastening the bicycle actuating device to a handlebar clamp of a bicycle,
wherein the fastening portion protrudes from the main body and the at least one fastening opening is formed as a through-opening that connects two fastening faces on opposite sides of the fastening portion to one another.

2. The bicycle actuating device according to claim 1, wherein the at least one fastening opening includes a plurality of fastening openings, and wherein the fastening portion is formed as an elongate web and comprises the plurality of fastening openings that are arranged along a first predetermined direction and formed as through-openings, wherein the fastening portion protrudes from the main body in the first predetermined direction.

3. The bicycle actuating device according to claim 2, wherein portions of the fastening portion have a constant cross-sectional contour in the cross section perpendicular to the first predetermined direction.

4. The bicycle actuating device according to claim 3, wherein the two fastening faces on opposite sides of the fastening portion are formed in such a manner that the fastening portion and a further component part, at least certain portions of which have substantially the same shape as the fastening portion, can be stacked on top of one another in any order along a second predetermined direction,
wherein the second predetermined direction runs parallel to an axial direction of the at least one fastening opening of the fastening portion and runs perpendicular to the first predetermined direction.

5. The bicycle actuating device according to claim 4, wherein the fastening portion and the further component part, when stacked on top of one another, are in an engagement that prevents a mutual relative movement in and counter to a third predetermined direction, which runs perpendicular to the second predetermined direction and perpendicular to the first predetermined direction.

6. A bicycle actuating system, comprising:
a bicycle actuating device, including:
a main body in the form of a housing,
an actuating element, which is mounted so as to be able to move on the main body,
a fastening portion having at least one fastening opening for fastening the bicycle actuating device to a handlebar clamp of a bicycle,
wherein the fastening portion protrudes from the main body and the at least one fastening opening of the fastening portion is formed as a through-opening that connects two fastening faces on opposite sides of the fastening portion to one another;
at least one spacer formed separately from the bicycle actuating device and having at least one fastening opening formed as a through-opening, having a plurality of such fastening openings arranged along a line,
wherein the spacer is configured to be selectively mounted on either one of the two fastening faces of the fastening portion, so that the at least one fastening opening of the bicycle actuating device and the at least one fastening opening of the spacer are arranged coaxially with one another.

7. The bicycle actuating system, according to claim 6, further comprising:
a handlebar clamp,
wherein the fastening portion of the bicycle actuating device is configured to be fastened to the handlebar clamp,
wherein the first predetermined direction, when the bicycle actuating device is fastened to the handlebar clamp, runs substantially parallel to an axis of the handlebar clamp, and
wherein the bicycle actuating device further comprises a brake actuating device, which is configured to be mounted between circumferential ends of the handlebar clamp.

8. The bicycle actuating system according to claim 7, further comprising:
a clamp adapter formed separately from the handlebar clamp and is configured to be selectively attached to the handlebar clamp in various circumferential positions, and the clamp adapter having a fastening portion having at least one fastening opening,
wherein the fastening portion of the bicycle actuating device is configured to be fastened directly or indirectly to the fastening portion of the clamp adapter, so that the fastening opening of the clamp adapter and the fastening opening of the bicycle actuating device are arranged coaxially with one another.

9. The bicycle actuating system according to claim 8, further comprising:
a second bicycle actuating device having a second fastening portion and a second fastening opening formed therein,
wherein the bicycle actuating device and the second bicycle actuating device can be mounted on one another such that the fastening portion and the second fastening portion are stacked on top of one another and the at least one fastening opening of the fastening portion and the second fastening opening of the second fastening portion are arranged coaxially with one another.

10. The bicycle actuating system according to claim 9, wherein the spacer, the bicycle actuating device, and the second bicycle actuating device are mounted on one another in various configurations and are able to be fastened to the handlebar clamp,
wherein the spacer is arranged, in one of the configurations, between the fastening portion and the second fastening portion of the bicycle actuating device and the second bicycle actuating device and is arranged, in another of the configurations, between the handlebar clamp and the fastening portion and the second fastening portion, which are directly mounted on one another, of the bicycle actuating device and the second bicycle actuating device.

11. The bicycle actuating system according to claim 10, wherein the bicycle actuating device is a gearshift-mechanism actuating device, a seat post actuating device or an e-bike-controller actuating device.
